(19) United States
(12) Patent Application Publication
(10) Pub. No.: US 2026/0153817 A1
(43) Pub. Date: Jun. 4, 2026

(54) SLID MEMBER, FIXING APPARATUS, IMAGE FORMING APPARATUS, AND MANUFACTURING METHOD FOR SLID MEMBER

(71) Applicant: CANON KABUSHIKI KAISHA, Tokyo (JP)

(72) Inventors: AKIRA OKANO, Kanagawa (JP); YUSUKE BABA, Kanagawa (JP); DAIGO MATSUURA, Tokyo (JP); MISA KAWASHIMA, Chiba (JP)

(21) Appl. No.: 19/404,133

(22) Filed: Dec. 1, 2025

(30) Foreign Application Priority Data
Dec. 4, 2024 (JP) 2024-210989

(51) Int. Cl. G03G 15/20

(52) U.S. Cl. CPC G03G 15/2025; G03G 15/2032; G03G 15/2064; G03G 2215/2038

(57) ABSTRACT

A slid member includes a metal base having a surface on which base projection portions are formed and a slid layer that covers the surface. A height (H) of surface projection portions, which are formed with the base projection portions and the slid layer, is 230 μm or more. A diameter (d) of a tip area of the base projection portions is 400 μm or less. A rising angle (θ) of the base projection portions is from 35° to 80°. A center-to-center distance (W) (mm) between a center of the base projection portion X and a center of the base projection portion Y is 1.2 or less. A relationship of W×1,000>d+2(H1/tan θ) is satisfied. A thickness (hA) of the slid layer of a tip area is larger than a thickness (hB) of the slid layer coating a flat portion between the base projection portions.

### BACKGROUND

### Field of the Technology

The present disclosure relates to a slid member, a fixing apparatus, an image forming apparatus including the fixing apparatus, and a manufacturing method for the slid member.

### Description of the Related Art

In recent years, the market of print-on-demand for printing commercial printed matters such as catalogs, posters, and brochures in accordance with a required number of copies or continuously printing various kinds of bills or direct mail while changing part of print contents for each customer has been expanding. These days, electrophotographic image forming apparatus for print-on-demand are required to perform printing at a higher printing speed.

In order to achieve a higher printing speed, energy that is sufficient to fix an unfixed toner image formed on a recording material such as a paper sheet to the recording material is required to be applied to the unfixed toner image within a short period of time. As one method therefor, there is a method using a fixing apparatus with a fixing nip having a large width, which allows application of energy to an unfixed toner image for a relatively longer period of time. Here, the term “width of the fixing nip” refers to a length of a contact portion between a fixing rotary member for heating an unfixed toner image and a pressure rotary member arranged so as to be opposed to the fixing rotary member, in a conveyance direction of a recording medium. The fixing apparatus with the fixing nip having a large width may hereinafter be referred to also as “wide-nip fixing apparatus”.

In order to ensure excellent image quality in such a wide-nip fixing apparatus, it is essential to more reliably prevent slip between the fixing rotary member and the recording medium and slip between the pressure rotary member and the recording medium.

Further, as the fixing apparatus, there has been known a fixing apparatus including:
(i) a rotatable endless belt (fixing rotary member);
(ii) a pressure member for forming a nip portion in cooperation with the belt, in which a recording medium is to be nipped between the pressure member and the belt to be conveyed; and
(iii) a backup member that is slid on an inner peripheral surface of the belt at the nip portion.

Further, in order to reduce sliding resistance between the backup member and the belt, there has been proposed a configuration using a slid member between the backup member and the belt (Japanese Patent Laid-Open No. 2008-275927 and Japanese Patent Laid-Open No. 2023-125019). Lubricating oil or grease is applied and supplied as a lubricant onto the inner peripheral surface of the belt so as to further reduce the sliding resistance between the inner peripheral surface of the belt and a slid surface of the slid member.

Further, regarding a surface of the slid member, a surface material and a surface shape of the slid member for reducing the sliding resistance have been proposed. For example, in Japanese Patent Laid-Open No. 2008-275927, the sliding resistance is reduced by using a low-friction member as a material for the surface of the slid member and forming an uneven shape including recesses and projections on the surface.

A driving torque for the belt is strongly affected by the sliding resistance. Thus, in order also to reduce the driving torque, the sliding resistance is required to be reduced. In view of the foregoing, there has been proposed a configuration in which a plurality of projection portions are formed on the surface of the slid member, which is in contact with the inner peripheral surface of the belt, and a slid layer is formed on the projection portions to thereby reduce the driving torque. However, there is concern that the slid layer may be worn by abrasion due to long time of use, resulting in an increase in driving torque. Thus, Japanese Patent Laid-Open No. 2023-125019 discloses a configuration of the slid member in which a thickness of the slid layer on the projection portions is increased by regulating a width of a tip surface of each of the projection portions without causing an increase in torque even after endurance.

For the slid member on which a plurality of independent projection portions are formed, recessed portions are in communication with one another. Thus, such a slid member has advantages in that foreign matters resulting from abrasion powder of the belt and/or the slid layer is hardly jammed in a contact portion between the surface of the slid member and the inner peripheral surface of the belt, and oil flows with high flowability.

In an electrophotographic image forming apparatus suitable for print-on-demand, durability is required to be further improved in accordance with a higher printing speed. In a case where the fixing apparatus including the slid member is used for a long period of time, the slid layer on the tip surfaces of the projection portions is abraded and heights of the projection portions are reduced. As a result, foreign matters resulting from abrasion powder of the belt and/or the slid layer may be caught between the belt and the slid member, resulting in that pressure unevenness may be caused, leading to an image defect. Further, the slid layer may be separated from an edge portion of the tip surface of the projection portion on an upstream side in the conveyance direction, and an increase in torque may occur due to exposure of a metal layer of a base in the projection portions. It is considered that this increase in torque is caused due to a relatively smaller thickness of the slid layer on the edge portion of the tip surface of the projection portion than a thickness of the slid layer on a center portion of the tip surface of the projection portion. That is, for further improvement of the durability of the slid member, there is room for improvement in terms of the thickness of the slid layer.

### SUMMARY

According to an embodiment of the present disclosure, a slid member includes: a metal base having a surface on which a plurality of base projection portions are formed; and a slid layer that covers the surface of the metal base on which the plurality of base projection portions are formed, wherein a height H of surface projection portions, which are formed with the base projection portions and the slid layer that covers the base projection portions, is 230 μm or more, wherein a diameter “d” of a tip area of each of the base projection portions is 400 μm or less, wherein a rising angle θ of each of the base projection portions is from 35° to 80°, wherein, assuming that any appropriate base projection portion among the base projection portions is defined as a base projection portion X and a base projection portion among the base projection portions being closest to the base projection portion X is defined as a base projection portion Y, a center-to-center distance W (mm) between a center of the base projection portion X and a center of the base projection portion Y is 1.2 or less, wherein a height H1 of the base projection portions, the diameter “d”, the rising angle θ, and the center-to-center distance W satisfy a relationship of W×1,000>d+2 (H1/tan θ), and wherein a thickness hA of the slid layer of a tip area of the surface projection portions is larger than a thickness hB of the slid layer coating a portion between the base projection portions.

According to another embodiment of the present disclosure, a fixing apparatus is configured to fix an unfixed toner image born on a recording material to the recording material and includes: a fixing rotary member; a pressure rotary member, which is arranged so as to be opposed to the fixing rotary member, and forms a nip portion in cooperation with the fixing rotary member; a slid member, which is arranged in an inner side of the fixing rotary member, and has a slid surface being contactable with an inner peripheral surface of the fixing rotary member through a lubricant; a pressing member, which is arranged in the inner side of the fixing rotary member and is configured to press the fixing rotary member against the pressure rotary member through the slid member; and a heater configured to heat the fixing rotary member, wherein the surface of the slid member on which the surface projection portions are provided is arranged so as to be opposed to the inner peripheral surface of the fixing rotary member.

According to the present disclosure, it is possible to provide: the slid member capable of suppressing exposure of a metal base or separation of a slid layer due to abrasion of the slid layer even during and after use for a long period of time; the fixing apparatus including the slid member; an image forming apparatus including the fixing apparatus; and a manufacturing method for a slid member.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an image forming apparatus.

FIG. 2 is a sectional view of a fixing apparatus.

FIG. 3 is an enlarged sectional view of a region including a nip portion, which is surrounded by a dotted line in FIG. 2.

FIG. 4A is a partially enlarged sectional view of a slid member.

FIG. 4B is an enlarged sectional view of a base projection portion of the slid member.

FIG. 5A is a view of distribution of a plurality of base projection portions formed on a slid surface of the slid member.

FIG. 5B is a sectional view of illustrating a thickness of a slid layer on a flat portion.

FIG. 6 is an enlarged sectional view of an edge portion of a tip area of the base projection portion of the slid member.

### DESCRIPTION OF THE EMBODIMENTS

Herein, the descriptions “XX or more and YY or less” and “from XX to YY” representing numerical ranges each mean a numerical range including a lower limit and an upper limit that are end points unless otherwise stated. In addition, when numerical ranges are described in a stepwise manner, the upper limits and lower limits of the respective numerical ranges can be appropriately combined. In the present disclosure, for example, the description such as “at least one selected from a group consisting of XX, YY, and ZZ” refers to any one of XX, YY, ZZ, a combination of XX and YY, a combination of XX and ZZ, a combination of YY and ZZ, and a combination of XX, YY, and ZZ.

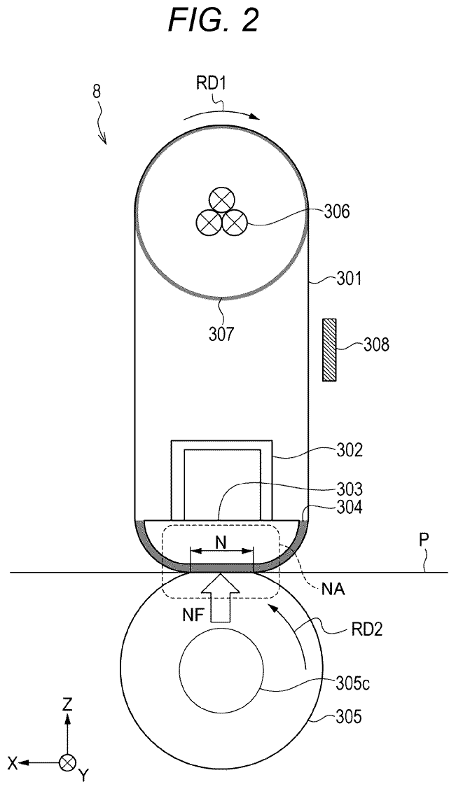

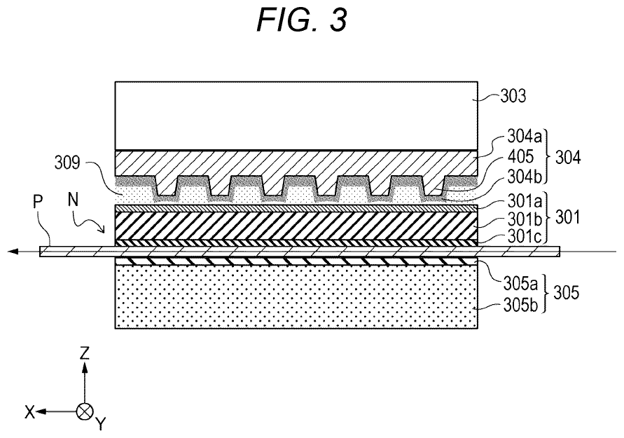

Now, an embodiment of a slid member 304 for fixing according to the present disclosure and an embodiment of a fixing apparatus 8 according to the present disclosure are described with reference to FIG. 2 and FIG. 3. FIG. 2 is a sectional view of the fixing apparatus 8. In FIG. 2, an X direction is a conveyance direction of a recording material P, a Y direction is a direction (width direction of the recording material P) intersecting with the conveyance direction of the recording material P, and a Z direction is a pressurizing direction in which the recording material P is pressurized at a nip portion N. In the embodiment, the X direction, the Y direction, and the Z direction are orthogonal to each other. Further, FIG. 3 is an enlarged sectional view of a region NA including the nip portion N, which is surrounded by a dotted line in FIG. 2.

The fixing apparatus 8 includes: a fixing rotary member 301; a pressure stay (hereinafter referred to as “stay”) 302; a pressure pad (hereinafter referred to as “pad”) 303; the slid member 304; a pressure rotary member 305; a heater 306; a heating roller 307; and a thermistor 308. The fixing rotary member 301 can be, for example, a belt having an endless shape. The pressure rotary member 305 is brought into abutment against an outer peripheral surface of the fixing rotary member 301 to pressurize the fixing rotary member 301 to thereby define the nip portion N in which the recording material P is to be nipped between the pressure rotary member 305 and the fixing rotary member 301 to be conveyed. The fixing rotary member 301 is rotated in a rotation direction RD 1, and the pressure rotary member 305 is rotated in a rotation direction RD 2.

The slid member 304 is slid on an inner peripheral surface of the fixing rotary member 301 at the nip portion N. The pad 303 serving as a backup member (pressing member) is arranged on an inner side of the fixing rotary member 301 so that the slid member 304 and the fixing rotary member 301 are sandwiched between the pad 303 and the pressure rotary member 305, to thereby back up the slid member 304. The slid member 304 is arranged so as to cover a surface (hereinafter also referred to as “outer surface”) of the pad 303 on a side opposed to the fixing rotary member 301. The slid member 304 is mounted so as to cover at least a position on the outer surface of the pad 303, which corresponds to the nip portion N. The slid member 304 may be provided over the entire outer surface of the pad 303 or may be mounted on only part of the outer surface corresponding to the nip portion N.

The stay 302 is arranged inside of the fixing rotary member 301 on a side opposite to the nip portion N in the presence of the pad 303 therebetween to thereby support the pad 303. The heating roller 307 is arranged on the inner side of the fixing rotary member 301 so that the fixing rotary member 301 is provided in a tensioned manner around the heating roller 307, to heat the fixing rotary member 301. The thermistor 308 serving as a temperature detection member detects a temperature of the fixing rotary member 301.

The fixing rotary member 301 has heat conductivity, heat resistance, and the like, and has a tubular shape with a small wall thickness. In the embodiment, as illustrated in FIG. 3, the fixing rotary member 301 includes: a base layer 301a; an elastic layer 301b that covers an outer peripheral surface of the base layer 301a; and a releasing layer 301c that covers an outer peripheral surface of the elastic layer 301b. The base layer 301a can be, for example, a polyimide resin (PI) layer having a thickness of 80 μm. The elastic layer 301b can be, for example, a layer containing a silicone rubber having a thickness of 300 μm. Further, the releasing layer 301c can be, for example, a fluororesin layer having a thickness of 30 μm. Examples of the fluororesin include a tetrafluoroethylene-perfluoroalkoxy ethylene copolymer resin (PFA) and a tetrafluoroethylene-hexafluoropropylene copolymer (FEP). The fixing rotary member 301 is provided in a tensioned manner around the pad 303 and the heating roller 307. An outer diameter of the fixing rotary member 301 can be, for example, 150 mm.

The pad 303 is arranged on the inner side of the fixing rotary member 301 so as to be opposed to the pressure rotary member 305 in the presence of the fixing rotary member 301 between the pad 303 and the pressure rotary member 305, to thereby define the nip portion N in which the recording material P is to be nipped between the fixing rotary member 301 and the pressure rotary member 305 to be conveyed. In the embodiment, the pad 303 is a substantially plate-like member that is elongated in a width direction of the fixing rotary member 301 (a longitudinal direction intersecting with the rotation direction RD1 (FIG. 2) of the fixing rotary member 301, and a rotation axis direction of the heating roller 307). The pad 303 is pressed against the pressure rotary member 305 in the presence of the fixing rotary member 301 therebetween, so that the nip portion N is defined. As a material for the pad 303, for example, a liquid crystal polymer (LCP) resin can be used. The slid member 304 is provided between the pad 303 and the fixing rotary member 301. Details of the slid member 304 are described later.

The pad 303 is supported by the stay 302 serving as a support member arranged inside of the fixing rotary member 301. The stay 302 is arranged on a side of the pad 303 opposite to the pressure rotary member 305, and supports the pad 303. The stay 302 is a reinforcing member with stiffness, which is elongated in the longitudinal direction of the fixing rotary member 301. The stay 302 is in abutment against the pad 303 to back up the pad 303. That is, when the pad 303 is pressed by the pressure rotary member 305, the stay 302 provides strength to the pad 303 so as to ensure a pressurizing force at the nip portion N.

The stay 302 is made of, for example, metal such as stainless steel, and has a substantially rectangular cross section (transverse section) being orthogonal to a longitudinal direction of the stay 302, which intersects with the rotation direction RD1 of the fixing rotary member 301. For example, it is preferred that strength of the stay 302 be ensured by forming the stay 302 with a substantially rectangular-shaped hollow transverse section with use of a drawn material of stainless steel (such as SUS304) having a wall thickness of 3 mm. The stay 302 may be formed to have a substantially rectangular cross section by combining and fixing a plurality of sheet metals to each other by welding or the like. Further, a material for the stay 302 is not limited to stainless steel as long as the strength is ensured.

The heating roller 307 is arranged on the inner side of the fixing rotary member 301, and tensions the fixing rotary member 301 together with the pad 303. The heating roller 307 is a cylindrical member formed of, for example, metal such as aluminum or stainless steel. The heater 306 for heating the fixing rotary member 301 is disposed inside the heating roller 307. Any heater may be used as the heater 306 as long as the heater can heat the heating roller 307. Examples of the heater 306 include a halogen heater and a carbon heater. The heating roller 307 is heated to a predetermined temperature by the heater 306.

The heating roller 307 has a pivot center in the vicinity of one end portion or a center portion, at the front and the rear in its longitudinal direction. The heating roller 307 also serves as a steering roller, which is pivoted about the pivot center with respect to the fixing rotary member 301 to generate a difference in tension in the fixing rotary member 301 in the longitudinal direction to thereby control a position of the fixing rotary member 301 in a main scanning direction. Further, the heating roller 307 also serves as a tension roller that is urged by a spring supported by a frame to apply predetermined tension to the fixing rotary member 301.

In the embodiment, the heating roller 307 is formed of, for example, a pipe made of stainless steel with a thickness of 1 mm. Further, in a case where a halogen heater is used as the heater 306, a number of halogen heaters may be one. In view of temperature distribution control of the heating roller 307 in the longitudinal direction (rotation axis direction), however, it is desired that a plurality of halogen heaters be provided. The plurality of halogen heaters provided as described above have light distributions being different from each other in the longitudinal direction, and hence a lighting ratio is controlled in accordance with a size of the recording material P. In the embodiment, three halogen heaters are arranged as the heater 306.

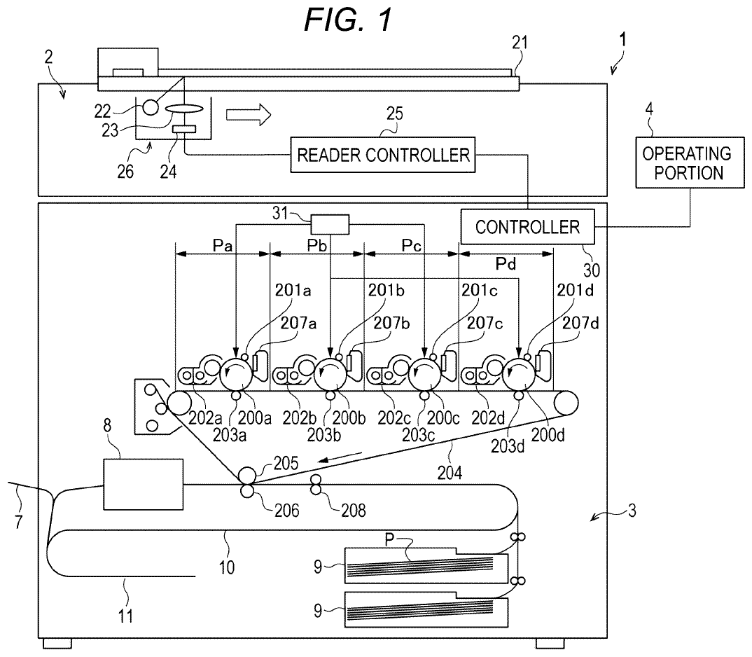

The fixing rotary member 301 is heated by the heating roller 307 that has been heated by the heater 306, to be controlled to a predetermined target temperature in accordance with a kind of the recording material P based on a temperature detected by the thermistor 308. The thermistor 308 is arranged so as to be opposed to the outer peripheral surface of the fixing rotary member 301 in the vicinity of a center part in the width direction of the fixing rotary member 301, through which the recording material P of every size that can be fixed by the fixing apparatus 8 is to pass. The thermistor 308 detects a temperature of the fixing rotary member 301, and a controller 30 (FIG. 1) controls electric power to be supplied to the heater 306 so that the temperature detected by the thermistor 308 becomes a target temperature. The thermistor 308 may be a non-contact sensor arranged in proximity to the outer peripheral surface of the fixing rotary member 301 or a contact sensor arranged in contact with the outer peripheral surface of the fixing rotary member 301.

The pressure rotary member 305 also serves as a drive roller that is rotated in the rotation direction RD2 while being in abutment against the outer peripheral surface of the fixing rotary member 301, to thereby apply a driving force to the fixing rotary member 301. The fixing rotary member 301 may be rotated in the rotation direction RD1 by driving the heating roller 307 as the drive roller with a drive source such as a motor. The fixing rotary member 301 may be rotated by the pressure rotary member 305 without application of the driving force to the heating roller 307, or the fixing rotary member 301 may be rotated by the heating roller 307 without application of the driving force to the pressure rotary member 305. That is, the drive roller for the fixing rotary member 301 may be at least any one selected from the group consisting of the pressure rotary member 305 and the heating roller 307.

The pressure rotary member 305 includes, for example: a metal core (shaft) 305c; an elastic layer 305b provided on an outer periphery of the metal core 305c; and a releasing layer 305a that covers an outer periphery of the elastic layer 305b. As the metal core 305c, for example, a roller made of stainless steel with a diameter of 72 mm can be used. The elastic layer 305b can be, for example, an electroconductive elastic layer containing a silicone rubber with a thickness of 8 mm. Further, the releasing layer 305a can be a fluororesin layer having a thickness of 100 μm. Examples of the fluororesin include a tetrafluoroethylene-perfluoroalkoxy ethylene copolymer resin (PFA). The pressure rotary member 305 is rotatably supported by a frame of the fixing apparatus 8. A gear is fixed to one end portion of the pressure rotary member 305. The pressure rotary member 305 is connected to and is driven by a drive source such as a motor through the gear.

The fixing apparatus 8 nips the recording material P bearing an unfixed toner image, at the nip portion N formed between the fixing rotary member 301 and the pressure rotary member 305, and heats the unfixed toner image while conveying the recording material P. As described above, the fixing apparatus 8 fixes a toner image onto the recording material P while conveying the recording material P in a nipped manner. Thus, the fixing apparatus 8 is required to have both a function of applying heat and pressure and a function of conveying the recording material P. The pressure rotary member 305 is pressurized against the slid member 304 by an urging device in the presence of the fixing rotary member 301 between the pressure rotary member 305 and the slid member 304. In the embodiment, a pressurizing force (NF) at the nip portion N during image formation, that is, a load value of a load applied to the pad 303 and the pressure rotary member 305 is 1,600 N. A nip width (length) of the nip portion N in the X direction (conveyance direction of the recording material) is set to 24.5 mm, and a width of the nip portion N in the Y direction (width direction of the recording material) is set to 326 mm.

The nip width of the nip portion N in the X direction (conveyance direction) is defined when the slid member 304 is pressed by the pressure rotary member 305 in the presence of the fixing rotary member 301 therebetween. A magnitude of the pressurizing force (NF) at the nip portion N is not particularly limited to 1,600 N. However, the pressurizing force (NF) on the nip portion N desirably has a magnitude that allows the fixing rotary member 301 to be sufficiently pressed by the pressure rotary member 305 so as not to cause slip between the recording material P passing through the nip portion N and the fixing rotary member 301 or the pressure rotary member 305. As one example, it is preferred that the load value of the load applied to the pad 303 and the pressure rotary member 305 be set to 900 N or more, in particular, 1,600 N or more.

### [Slid Member]

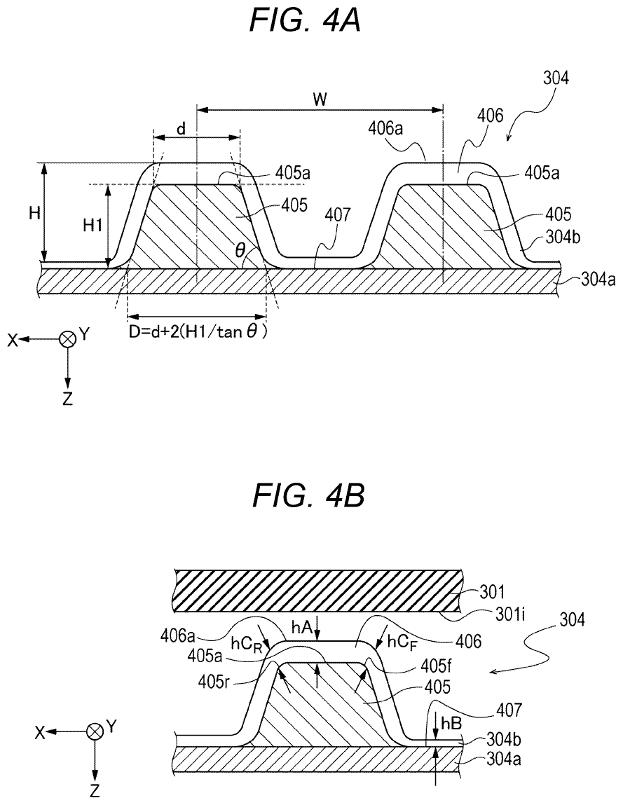

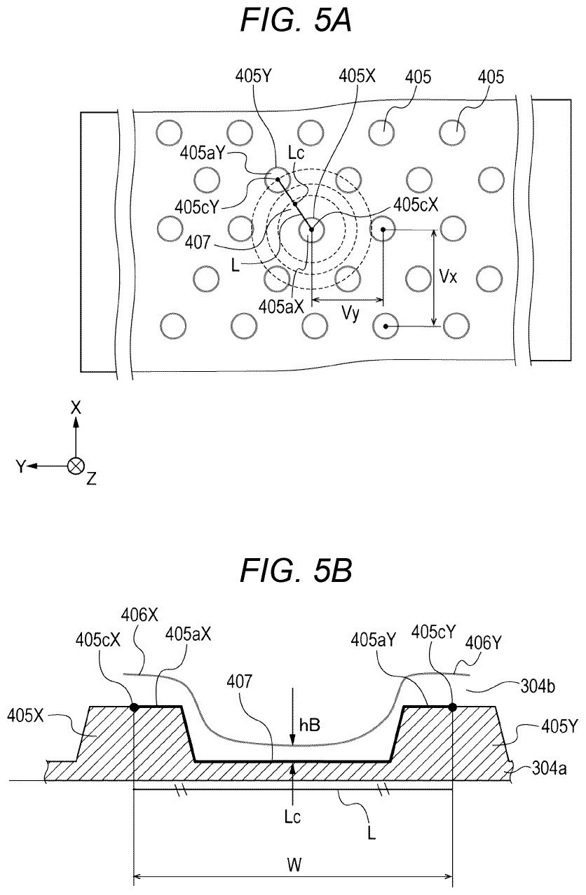

The slid member 304 is described with reference to FIG. 3, FIG. 4A, FIG. 4B, FIG. 5A, and FIG. 5B. FIG. 4A is a partially enlarged sectional view of the slid member 304. FIG. 4B is an enlarged sectional view of a base projection portion 405 of the slid member 304. FIG. 5A is a view of distribution of a plurality of base projection portions 405 formed on a slid surface of the slid member 304. FIG. 5B is a sectional view of illustrating a thickness hB of a slid layer 304b on a flat portion 407. The slid member 304 is fixed to the stay 302 in the presence of the pad 303 therebetween with fixing members such as screws. In the embodiment, the slid member 304 and the pad 303 are formed as separate members. However, the slid member 304 and the pad 303 may be integrated with each other. For a detailed description of the base projection portions 405 of the slid member 304, the base projection portions 405 are illustrated in a vertically inverted manner in FIG. 4A and FIG. 4B with respect to those in FIG. 3. The slid member 304 includes: a base 304a having the plurality of base projection portions 405 on a surface on one side; and the slid layer 304b that covers the surface of the base 304a on which the base projection portions 405 are formed. In the following description, the base projection portions 405 covered with the slid layer 304b are referred to as “surface projection portions 406”.

### <Base>

It is preferred that the base 304a have sufficient strength and heat resistance to prevent the base 304a from being deformed due to a pressing force applied to the slid member 304 by the pressure rotary member 305 through the fixing rotary member 301. Thus, a material for the base 304a is preferably metal. Specific examples of the material include stainless steel, aluminum, an aluminum alloy, nickel, and a nickel alloy. Specifically, the base 304a can be formed of, for example, stainless steel (such as SUS304) with a thickness of 1.3 mm. Here, the thickness of the base 304a refers to a thickness of part thereof without the base projection portions 405.

The plurality of base projection portions 405 form part of the base 304a. In view of uniformization of the pressure at the nip portion N, it is preferred that the plurality of base projection portions 405 be formed in the nip portion N so that a plurality of base projection portions 405 are arranged in the conveyance direction (X direction) of the recording medium and a plurality of base projection portions 405 are arranged in the direction intersecting with the conveyance direction (Y direction). The surface projection portions 406 are arranged so as to achieve both a uniform pressure distribution and a reduction in driving torque of the fixing rotary member 301. As one example, FIG. 5A is a plan view for illustrating distribution of the plurality of base projection portions 405 formed on the slid surface of the slid member 304 according to one embodiment of the present disclosure. The arrangement of the base projection portions 405 illustrated in FIG. 5A is one example, and the arrangement is not limited thereto. As illustrated in FIG. 5A, the base projection portions 405 are arranged evenly in the conveyance direction (X direction) and in the direction intersecting with the conveyance direction (Y direction), respectively. Regarding the arrangement in the direction intersecting with the conveyance direction (Y direction), it is preferred that the plurality of base projection portions 405 be arranged so that a projection portion-to-projection portion distance Vy between the base projection portions 405 is 2.0 mm or less, more preferably 1.7 mm or less. In a case where the distance between the base projection portions 405 is larger than 2.0 mm, a pressure distribution in which pressure greatly varies in the width direction of the recording material P (Y direction) may be generated, which may result in a streaky image defect in the conveyance direction (X direction).

As illustrated in FIG. 5A, the plurality of base projection portions 405 are arranged at equal intervals in the conveyance direction (X direction) and the direction intersecting with the conveyance direction (Y direction). In one example of the arrangement illustrated in FIG. 5A, a distance between a center of any appropriate one base projection portion 405X among the plurality of base projection portions 405 and a center of a base projection portion 405Y being closest to the base projection portion 405X, among the plurality of base projection portions 405, is defined as a center-to-center distance W (mm). A distance between centers of two base projection portions 405 being adjacent to each other in the Y direction is defined as the projection portion-to-projection portion distance Vy (mm). A relationship between the center-to-center distance W and the projection portion-to-projection portion distance Vy is expressed by the following expression.

$$Vy = W / √ 2 \times 2$$

Thus, when the center-to-center distance W (mm) between any appropriate one base projection portion 405X (base projection portion X) and the base projection portion 405Y (base projection portion Y) being closest to the base projection portion 405X is set to 1.2 or less, the projection portion-to-projection portion distance Vy in the Y direction is 1.7 mm, thus is 2.0 mm or less. Further, when the center-to-center distance W is smaller than 0.3 mm, the adjacent base projection portions 405 are connected to each other on a bottom surface, failing to ensure the flat portion 407. Accordingly, the center-to-center distance W is desirably 0.3 mm or more and 1.2 mm or less.

It is preferred that a shape of each of the plurality of base projection portions 405 be truncated conical. The truncated conical shape is suitable for allowing the amount of lubricant 309 that is sufficient to contribute to a reduction in driving torque for the fixing apparatus 8 to easily flow onto tip areas 406a of the surface projection portions 406. A tip area 405a of the base projection portion 405 has a substantially flat circular shape in plan view. However, a shape of the base projection portion 405 is not limited to any particular shape. As illustrated in FIG. 4A, the base projection portion 405 can have a truncated conical shape that has a bottom surface with a diameter D that is larger than a diameter “d” of the tip area 405a being a top surface. With the diameter “d” of the tip area 405a of the base projection portion 405 being smaller than 150 μm, when the slid member 304 is incorporated into the fixing apparatus 8 to be used, pressure is concentrated on the tip area 405a, resulting in that the slid layer 304b on the tip area 405a is easily abraded. Further, in a case where the diameter “d” of the tip area 405a of the base projection portion 405 is larger than 400 μm, a contact area between the surface projection portion 406 and the fixing rotary member 301 is increased, resulting in a larger driving torque for the fixing rotary member 301. Thus, a preferred range of the diameter “d” of the tip area 405a of the base projection portion 405 is 150 μm or more and 400 μm or less.

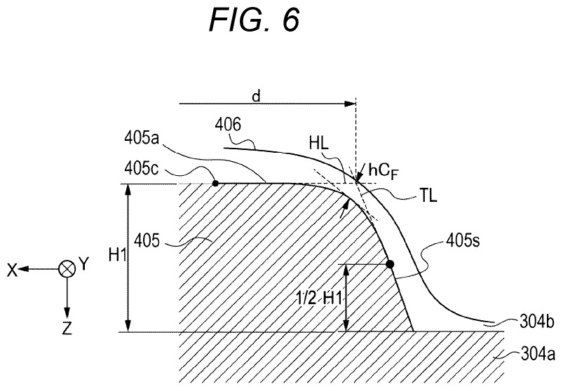

FIG. 6 is an enlarged sectional view of an edge portion of the tip area 405a of the base projection portion 405 of the slid member 304. As illustrated in FIG. 6, the edge portion of the tip area 405a may have a rounded shape. In this case, the diameter “d” (μm) of the tip area 405a of the base projection portion 405 is defined by an intersecting point between a horizontal line HL passing through a center 405c of the tip area 405a and a tangent line TL to an inclined surface 405s at one-half (½·H1) of a height H1 of the base projection portion 405 on each side.

As illustrated in FIG. 4A, the diameter D (μm) of the bottom surface of the base projection portion 405 can be expressed by the following Expression 1 using the diameter “d” of the tip area 405a of the base projection portion 405, the height H1 of the base projection portion 405, and a rising angle θ of the base projection portion 405.

$$D = d + 2 ( H 1 / tan θ ) \qquad ( Expression 1 )$$

The slid member 304 includes the slid surface that is arranged on the inner side of the fixing rotary member 301, and is contactable with the inner peripheral surface of the fixing rotary member 301 in the presence of the lubricant 309 between the slid member 304 and the inner peripheral surface. It is preferred that the slid member 304 and the fixing rotary member 301 be slid on each other in the presence of the lubricant 309 therebetween. In such a case, the flat portion 407 is desirably formed between the base projection portions 405 and has a uniform thickness so as not to prevent uniform flow of the lubricant 309. In order to ensure the flat portion 407, the following Expression 2 is desirably satisfied so that the base projection portions 405 do not overlap each other.

$$W \times 1 , 000 > d + 2 ( H 1 / tan θ ) \qquad ( Expression 2 )$$

A range of from 35° to 80° is preferred as the rising angle θ of the base projection portion 405. In a case where the rising angle θ is smaller than 35°, the center-to-center distance W (mm) is required to be increased so as to ensure the flat portion 407 with a sufficient area. However, when the center-to-center distance W (mm) is set larger than 1.2 as described above, a uniform pressure distribution cannot be ensured. Further, in a case where the rising angle θ is larger than 80°, a thickness of the slid layer 304b on the edge portions of the tip area 405a of the base projection portion 405 is small and hence the slid layer 304b is prone to separation. When the separation of the slid layer 304b occurs, the driving torque for the fixing rotary member 301 increases.

It is preferred that a height H of the surface projection portion 406 of the slid member 304 be 230 μm or more. Such a height is set so as to prevent occurrence of an image defect due to pressure unevenness caused by abrasion powder of the fixing rotary member 301 or abrasion powder of the slid layer 304b, which is generated due to endurance for a long period of time, being caught in the nip portion N. Thus, it is desired that the height of the base projection portion 405 be set so that the surface projection portion 406 after the formation of the slid layer 304b on the base projection portion 405 has a height of 230 μm or more. A manufacturing method for the base 304a having the plurality of base projection portions 405 is not limited to any particular method, and examples of the manufacturing method include chemical etching and press working.

### <Slid Layer>

The slid layer 304b covers the surface of the base 304a, on which the plurality of base projection portions 405 are formed. A material for forming the slid layer 304b is not limited to any particular material, and is preferably a resin excellent in heat resistance, abrasion resistance, and slidability on the inner peripheral surface of the fixing rotary member 301. Specific examples of such a material include polyether ether ketone (PEEK). Further, the material may contain a fluororesin (such as polytetrafluoroethylene (PTFE) or PFA) for achieving lower friction.

Regarding a layer thickness of the slid layer 304b of the slid member 304, a thickness hA of the slid layer 304b on the center portion of the tip area 405a of the base projection portion 405 is desirably larger than the thickness hB of the slid layer 304b on the flat portion 407. The surface projection portions 406 of the slid member 304 are slid on an inner surface 301i of the fixing rotary member 301. The slid layer 304b of the surface projection portion 406 gradually abrades, exposing the base 304a, and a durability life of the slid member 304 reaches its end. Thus, the improvement of the durability life is expected by increasing the thickness hA of the slid layer 304b of the tip area 406a of the surface projection portion 406. Meanwhile, in order to prevent obstruction of flow of the lubricant 309 and quickly remove, in a downstream direction, the abrasion powder of the slid layer 304b and the abrasion powder of the fixing rotary member 301 that are generated due to endurance for a long period of time, it is desired that a large flat portion 407 between the surface projection portions 406 be ensured. Further, the height H of the surface projection portion 406 is desirably set to 230 μm or more as described above. That is, in order to reliably set the height H of the surface projection portion 406 to 230 μm or more, the thickness hB of the slid layer 304b on the flat portion 407 is desirably adjusted so as not to be excessively large. An upper limit value of the height H of the surface projection portion 406 is not limited to any particular value, and may be large as long as processing thereof is allowed. For example, the height H of the surface projection portion 406 may be 230 μm or more and 1,000 μm or less, 230 μm or more and 500 μm or less, 230 μm or more and 300 μm or less, or 230 μm or more and 265 μm or less.

Further, a thickness hC (hC_{F}, hC_{R}) of the slid layer 304b formed on the edge portion of the tip area 405a of the base projection portion 405 can be set as follows. The thickness hC of the slid layer 304b formed on an upstream edge portion 405f, which is an upstream-side portion of the tip area 405a in a moving direction of the fixing rotary member 301 (the rotation direction RD1, the X direction, the conveyance direction) that is slid on the slid member 304, is referred to as “thickness hC_{F}”. The thickness hC of the slid layer 304b formed on a downstream edge portion 405r, which is a downstream-side portion of the tip area 405a in the moving direction of the fixing rotary member 301, is referred to as “thickness hC_{R}”. It is preferred that the thickness hC_{F} of the slid layer 304b formed on the upstream edge portion 405f, which is the upstream-side portion of the tip area 405a, be at least 30% or more of the thickness hA of the slid layer 304b formed on the center portion of the tip area 405a (hC_{F}≥0.3 hA). This is because, when the thickness hC of the slid layer 304b formed on the edge portion of the tip area 405a of the base projection portion 405 is small, the slid layer 304b is prone to separation. Further, it is desired that the thickness hC_{F} of the slid layer 304b on the upstream edge portion 405f (one side edge portion) be larger than the thickness hC_{R} of the slid layer 304b on the downstream edge portion 405r (another side edge portion) on a side opposite to the upstream edge portion 405f (hC_{F}>hC_{R}). This is because the slid layer 304b on the upstream edge portion 405f (one side edge portion) is more prone to abrasion than the slid layer 304b on the downstream edge portion 405r (another side edge portion).

### <Manufacturing Method for Slid Member>

As a manufacturing method for the slid member 304 according to the present disclosure, for example, a method including the following Step I and Step II is given.

Step I: prepare the base 304a having the base projection portions 405, on one surface. The base 304a can be produced by, for example, chemical etching or press working.

Step II: form the slid layer 304b as illustrated in FIG. 4B on the surface of the base 304a prepared in Step I, on which the base projection portions 405 are formed. A forming method for the slid layer 304b is not limited to any particular method, and examples of the forming method include Method (i) and Method (ii) described below.

Method (i): form a coating film of a resin solution in which a resin for forming the slid layer 304b is dissolved in an appropriate solvent, by applying the resin solution onto the surface of the base 304a, on which the base projection portions 405 are formed. Subsequently, dry the coating film to form the slid layer 304b.

Method (ii): form a coating film of a dispersion liquid of a resin for forming the slid layer 304b, by applying the dispersion liquid onto the surface of the base 304a, on which the base projection portions 405 are formed. Subsequently, dry and bake the coating film to form the slid layer 304b.

For improvement of the durability life of the slid member 304 and quick removal of the abrasion powder, the slid layer 304b is formed in Step II so that the thickness hA of the slid layer 304b on the tip area 405a is set larger than the thickness hB of the slid layer 304b on the flat portion 407 (hA>hB). Now, the thickness hB of the slid layer 304b is described with reference to FIG. 5A and FIG. 5B. First, any appropriate one base projection portion 405X is selected from the plurality of base projection portions 405. Concentric circles are drawn around a center 405cX of a tip area 405aX of the base projection portion 405X so that the base projection portion 405Y closest thereto is determined. A thickness of the slid layer 304b on the flat portion 407 at a midpoint Lc of a line L that connects the center 405cX of the base projection portion 405X and a center 405cY of a tip area 405aY of the base projection portion 405Y to each other is referred to as “thickness hB”. When there are a plurality of base projection portions 405Y with respect to the base projection portion 405X, the thickness hB of the slid layer 304b at the midpoint Lc is calculated for each of the plurality of base projection portions 405Y. An average value of the plurality of thicknesses hB calculated is set as the thickness hB of the flat portion 407 for the thickness hA of the slid layer 304b on the base projection portion 405X. For the observation of a cross section of the slid member 304 taken along the line L, a cross section passing through the center 405cX of the base projection portion 405X and the center 405cY of the base projection portion 405Y is actually obtained by cutting, and is observed with an electron microscope (SEM) to thereby measure the thicknesses hA and hB of the slid layer 304b.

Further, as described above, the thicknesses hC_{F} and hC_{R} of the slid layer 304b on the upstream edge portion 405f and the downstream edge portion 405r of the tip area 405a are a thickness on the upstream side and a thickness on the downstream side in the conveyance direction (X direction). Each edge portion of the tip area 405a is defined by, as illustrated in FIG. 6, an intersecting point between the horizontal line HL passing through the center 405c of the tip area 405a and the tangent line TL passing through the one-half height (½·H1) of the inclined surface 405s of the base projection portion 405. The thicknesses hC_{F} and hC_{R} of the slid layer 304b on the upstream edge portion 405f and the downstream edge portion 405r of the tip area 405a are each a distance between the above-mentioned intersecting point and a foot of a perpendicular that passes through the intersecting point and orthogonally intersecting with the base projection portion 405.

In a case where a cross section of a surface projection portion 406X is cut out so that the thicknesses hA, hB, hC_{F} and hC_{R} are measured, a surface projection portion 406Y, which is located at the shortest distance from the surface projection portion 406X, may be present at an oblique phase with respect to the X direction and the Y direction depending on the arrangement of the plurality of surface projection portions 406. In a case where the surface projection portion 406X is present at an oblique phase with respect to the conveyance direction (X direction), the thicknesses hC_{F} and hC_{R} of the slid layer 304b at an upstream edge portion and a downstream edge portion of the surface projection portion 406X cannot be precisely measured. In this case, another surface projection portion 406, which is different from the surface projection portion 406X cut out at an oblique phase, is cut out in the conveyance direction (X direction) so that the thicknesses of the slid layer 304b are measured. Evaluation values (such as hA, hB, hC_{F}, and hC_{R}) of the slid member 304 are determined by using average values of the results of measurement of some of the surface projection portions 406, and are treated as characteristic values of the slid member 304.

In order to satisfy the relationships of the thicknesses of the slid layer 304b (hA>hB, hC_{F}≥0.3 hA, and hC_{F}>hC_{R}), it is desired that Step II include, for example, steps as follows. Step II may specifically include a coating step of spray-coating the surface of the base 304a made of metal (metal base) obtained in Step I, on which the base projection portions 405 are formed, with a coating material containing a resin for forming the slid layer 304b. Step II may further include a baking step of forming a resin layer by baking the resin contained in the applied coating material. The coating step may be a step of applying the coating material while rotating the base 304a so that a centrifugal force of 1.5 G or more and 3.0 G or less is applied to the tip area 405a of the base projection portion 405 in a direction toward the tips of the base projection portions 405. The baking step may include: a heating step of heating the base 304a to a melting point or higher of the resin for forming the resin layer in a state in which the base 304a is installed in a direction in which a gravitational force is applied in the direction toward the base projection portions 405; and a subsequent cooling step of cooling the base 304a, which is kept in the above-mentioned direction. Through Step II, the slid member 304 including the slid layer 304b having the thicknesses hA, hB, hC_{F}, and hC_{R} that satisfy the above-mentioned relationships of hA>hB, hC_{F}≥0.3 hA, and hC_{F}>hC_{R} can be obtained.

The method using a centrifugal force generated by the rotation can effectively increase the thickness hA of the slid layer 304b on the tip area 405a with respect to the thickness hB of the slid layer 304b on the flat portion 407 as compared to the method of performing spray coating with the surface with the base projection portions 405 facing downward. However, when the centrifugal force is more than 3.0 G, scattering of a coating liquid occurs, resulting in lower coating efficiency. Thus, it is preferred that the centrifugal force be set to 3.0 G or less. When the centrifugal force is less than 1.5 G, the thickness hA of the slid layer 304b on the tip area 405a of the base projection portion 405 is not set to be sufficiently large. Thus, it is preferred that the centrifugal force be set to 1.5 G or more.

After the application of the coating liquid, a solvent is volatized to a certain degree while the base 304a is being rotated, so that the coating liquid is dried. When the rotation is stopped in a state in which viscosity of the coating liquid remains low, the coating liquid flows in a direction of the gravitational force at that time. Thus, the slid layer 304b with unevenness in thickness is formed. Accordingly, before the rotation is stopped, the solvent is volatized to a certain degree from the coating liquid, and then the coating liquid is dried.

In the baking step of forming the resin layer, the base 304a is arranged in a similar manner so that stress (for example, a gravitational force) is applied in the direction toward the tips of the base projection portions 405, and is heated to a melting point or higher of the resin for forming the slid layer 304b. In the baking step, the resin for forming the slid layer 304b is melted to be fused together to thereby form a uniform film. At this time, when baking is performed at the melting point or higher in a state in which stress is not applied in the direction toward the tips of the base projection portions 405, that is, in a state of the surface having the base projection portions 405 facing upward, flow of the resin from the tip areas 405a of the base projection portions 405 toward the flat portions 407 occurs. As a result, in particular, the thicknesses hC_{F} and hC_{R} of the slid layer 304b on the edge portions of the tip area 405a of the base projection portion 405 are reduced. In some cases, a metal surface of the base 304a itself may be exposed due to liquid runout of the resin. Meanwhile, the resin can be prevented from flowing from the tip areas 405a of the base projection portions 405 toward the flat portions 407, by baking so that stress is applied in the direction toward the tips of the base projection portions 405. In this manner, occurrence of film breakage of the resin layer on the tip area 405a of the base projection portion 405 is prevented while a sufficient film thickness of the resin layer on the tip area 405a of the base projection portion 405 is ensured. Thus, the slid layer 304b with high durability can be formed.

The thickness hA of the slid layer 304b on the tip area 405a of the base projection portion 405 is not restricted to any particular thickness. However, in order to maintain a projecting shape of the base projection portion 405 and prevent an increase in driving torque for the fixing rotary member 301, it is preferred that the thickness hA be set to from 20 μm to 100 μm, in particular, from 20 μm to 60 μm.

Further, for the height H of the surface projection portions 406 of the slid member 304, it is required that a difference in the height H between the surface projection portions 406 adjacent to each other be small. Thus, for the slid layer 304b, a smoothing process may be performed on the tip portions of the surface projection portions 406 as required. Examples of means for performing the smoothing process include processing methods such as hot press and polishing.

### <Image Forming Apparatus>

Now, an electrophotographic image forming apparatus (hereinafter also referred to as “image forming apparatus”) according to one embodiment of the present disclosure is described with reference to FIG. 1. FIG. 1 is a sectional view of an image forming apparatus 1. The image forming apparatus 1 including a plurality of electrophotographic photosensitive drums, which is capable of forming color images, is described below as an example. However, the image forming apparatus 1 is not limited to such an image forming apparatus, and may be an image forming apparatus that forms single-color images.

The image forming apparatus 1 includes: a main body 3; and an image reading unit 2 arranged on top of the main body 3. The image reading unit 2 includes: a platen glass 21; a light source 22; an optical member 23; a CCD sensor 24; and a reader controller 25. An optical unit 26 includes the light source 22, the optical member 23, and the CCD sensor 24, and is capable of reciprocating in a sub-scanning direction (direction indicated by the outlined arrow). The image reading unit 2 reads an image of an original placed on the platen glass 21. Light emitted from the light source 22 is reflected by the original to form an image on the CCD sensor 24 through the optical member 23 such as a lens. When the optical unit 26 performs scanning in the direction indicated by the outlined arrow, the CCD sensor 24 converts the reflected light from the original into an image signal for each line (electric signal data string), to transmit the image signal to the reader controller 25. The image signal obtained by the CCD sensor 24 is transmitted from the reader controller 25 to the controller 30 provided in the main body 3. The controller 30 performs image processing on the image signal in accordance with a plurality of image forming portions Pa, Pb, Pc, and Pd described later. The controller 30 can also receive an image signal from an external host apparatus such as a print server. The image forming apparatus 1 can perform an image forming operation in accordance with an instruction from an operating portion 4 or the external host apparatus.

The main body 3 of the image forming apparatus 1 includes the plurality of image forming portions Pa, Pb, Pc, and Pd. Each of the plurality of image forming portions Pa, Pb, Pc, and Pd performs image formation based on the above-mentioned image signal. In the present disclosure, the image forming portion Pa forms a yellow (Y) image, the image forming portion Pb forms a magenta (M) image, the image forming portion Pc forms a cyan (C) image, and the image forming portion Pd forms a black (Bk) image. The controller 30 generates a pulse signal that has been subjected to pulse-width modulation (PWM) corresponding to each color, based on the image signal. The controller 30 controls an exposure device (polygon scanner) 31 based on the pulse-width modulated pulse signal so that laser beams corresponding to the colors are output from the exposure device 31. The laser beams output from the exposure device 31 are radiated onto photosensitive drums 200a, 200b, 200c, and 200d serving as image bearing members of the image forming portions Pa to Pd, respectively. The image forming portions Pa to Pd have substantially the same structure. Thus, the image forming portion Pa is described below, and description of the other image forming portions Pb, Pc, and Pd is omitted.

A primary charger 201a uniformly charges a surface of the photosensitive drum 200a that is rotated in the direction indicated by the arrow, at a predetermined potential. The exposure device 31 radiates the laser beam that has been pulse-width modulated in accordance with image information, onto the surface of the photosensitive drum 200a that has been uniformly charged, to thereby form an electrostatic latent image. A developing device 202a develops the electrostatic latent image on the surface of the photosensitive drum 200a with a yellow toner to thereby form a yellow toner image. A primary transfer roller 203a performs an electric discharge from a back surface of an intermediate transfer belt 204, and applies a primary transfer bias of a polarity opposite to that of the toner, to thereby transfer the toner image formed on the photosensitive drum 200a onto the intermediate transfer belt 204. A residual toner on the surface of the photosensitive drum 200a is removed with a cleaner 207a.

The toner image on the intermediate transfer belt 204 is conveyed to the subsequent image forming portion Pb so that a magenta toner image is transferred onto the yellow toner image in a superimposed manner. Similarly, in the image forming portions Pc and Pd, a cyan toner image and a black toner image are sequentially transferred. As a result, the toner images of four colors are formed on a surface of the intermediate transfer belt 204 in a superimposed manner. The toner images that have passed through the image forming portion Pd are conveyed to a secondary transfer portion including a pair of secondary transfer rollers 205 and 206. Meanwhile, after waiting at a registration portion 208, the recording material P fed from a feed cassette 9 is conveyed from the registration portion 208 to the secondary transfer portion at timing that is controlled for positional registration between the toner images formed on the intermediate transfer belt 204 and the recording material P. When a secondary transfer electric field of a polarity opposite to that of the toner images on the intermediate transfer belt 204 is applied at the secondary transfer portion, the toner images are transferred onto the recording material P. After that, the toner images on the recording material P are heated and pressurized by the fixing apparatus 8 serving as an image heating apparatus, to be fixed onto the recording material P. After passing through the fixing apparatus 8, the recording material P is discharged to a delivery tray 7 of the image forming apparatus 1.

In a case where an image forming mode is a duplex printing mode, an image is formed on a first surface of the recording material P, and then, the recording material P is reversed by a reversing portion 11 provided inside the image forming apparatus 1, to be conveyed again to the secondary transfer portion through a duplex-printing conveyance path 10. After toner images are transferred onto a second surface opposite to the first surface of the recording material P at the secondary transfer portion, the toner images are fixed onto the second surface of the recording material by the fixing apparatus 8. The recording material P with both surfaces having the images formed thereon is discharged to the delivery tray 7.

### EXAMPLES

Now, the present disclosure is specifically described by way of Examples. The slid member 304 and the fixing apparatus 8 according to the present disclosure are not limited to configurations that are embodied in the following Examples.

### Example 1

### (Preparation of Base)

The base 304a made of stainless steel (SUS304) having a plate-like shape with a thickness of 1.3 mm, a width of 27.5 mm, and a length of 390 mm orthogonal to a width direction is prepared.

Next, the base projection portions 405 are formed on one of the surfaces of the base 304a by chemical etching. Each of the base projection portions 405 is formed in a truncated conical shape with the tip area 405a having the diameter “d” of 350 μm, the height H1 of 250 μm, the inclined surface 405s having an angle (rising angle of the base projection portion 405) of 70°, and the bottom surface having the diameter D of 532 μm. Further, the plurality of base projection portions 405 are arranged so that the center-to-center distance W between the base projection portions 405 with the shortest distance therebetween is set to 1.0 mm, and distances between the base projection portions 405 in the X direction and the Y direction (projection portion-to-projection portion distances Vx and Vy) are equal to each other. The projection portion-to-projection portion distances Vx and Vy between the plurality of base projection portions 405 in the X direction and the Y direction is 1.4 mm.

### (Formation of Slid Layer)

A dispersion liquid of polyether ether ketone (PEEK) (product name: VICOTE (trademark) F817, manufactured by Victrex Plc.) is prepared. A coating material had a viscosity of 63 mPa's (23° C.). Subsequently, the base 304a that had been prepared as described above is fitted over an outer peripheral surface of a core having an outer diameter of 80 mm. The dispersion liquid is applied onto the base 304a with use of a spray gun (product name: W-101, manufactured by ANEST IWATA Cooperation) while the base 304a is being rotated at 200 rpm, to thereby form a coating film of the dispersion liquid. At this time, a centrifugal force of 1.9 G is applied to the tip areas 405a of the base projection portions 405. After the completion of application, the rotation is continued for 10 minutes. Then, the apparatus is stopped, and the base 304a is removed therefrom. Subsequently, the base 304a with the coating film formed thereon is placed in a heating furnace to be heated at a temperature of 120° C. for 5 minutes. After the coating film is dried, the base 304a is heated at a temperature of 400° C. for 15 minutes to bake the coating film. In this manner, a first PEEK resin layer is formed so that the slid layer 304b on the tip area 405a of the base projection portion 405 had a thickness of 10 μm.

A step of applying a dispersion liquid of polyether ether ketone (PEEK) (product name: VICOTE (trademark) F804, manufactured by Victrex Plc.) onto the first PEEK resin layer formed as described above is carried out. A coating material had a viscosity of 92 mPa's (23° C.). First, the base 304a that had been prepared as described above is fitted over an outer peripheral surface of a core having an outer diameter of 80 mm. The dispersion liquid is applied onto the base 304a with use of a spray gun (product name: W-101, manufactured by ANEST IWATA Cooperation) while the base 304a is being rotated at 200 rpm, to thereby form a coating film of the dispersion liquid. At this time, a centrifugal force of 1.9 G is applied to the tip areas of the surface projection portions 406. After the completion of application, the rotation is continued for 10 minutes. Then, the apparatus is stopped, and the base 304a is removed therefrom. Subsequently, the base 304a with the coating film formed thereon is placed in the heating furnace to be heated at a temperature of 120° C. for 5 minutes to thereby dry the coating film. After that, the base 304a is set in the heating furnace so that the surface with the base projection portions 405 faces downward and an inclination at 15° is formed in the width direction. The base 304a is heated at a temperature of 400° C. for 15 minutes to bake the coating film. Thus, a second PEEK resin layer is formed. Spraying conditions are set so that the resultant second PEEK layer had a thickness of 50 μm. In this manner, the slid layer 304b including the first PEEK resin layer and the second PEEK resin layer is formed on the surface of the base 304a, on which the base projection portions 405 are formed. The base projection portions 405 are coated with the slid layer 304b to thereby form the surface projection portions 406.

### (Smoothing Process)

Subsequently, smoothing process is performed so as to achieve a uniform height of the surface projection portion 406. The base 304a covered with the slid layer 304b is placed on a hot plate (length of 600 mm×width of 600 mm×thickness of 60 mm) heated at 200° C., which is a temperature equal to or higher than a glass transition point and equal to or lower than a melting point of PEEK for forming the slid layer 304b so that the surface projection portions 406 are in contact with the hot plate. The slid layer 304b is pressed against the hot plate so that a pressure of 1.0 MPa is applied to the surface projection portions 406, by using a heat press machine (product name: 150 ton press machine, model: PEF-150, manufactured by KANSAI ROLL Co., Ltd.), and this state is kept for 10 minutes. After that, the pressing state is released, and the slid layer 304b is stationarily placed in an environment at normal temperature (25° C.). In this manner, the tip portions of the surface projection portions 406 are smoothed to reduce a variation in height. As a result, the slid member 304 according to Example 1 is obtained.

The resultant slid member 304 is subjected to the following evaluations. It is difficult to evaluate the same individual in Evaluation 1 and 1. Thus, the evaluations are carried out, using the slid members 304 produced under the same manufacturing conditions, as the same individual.

### <Evaluation 1>Measurement of Thickness of Slid Layer

First, the arrangement of the surface projection portions 406 is observed from the surface side of the slid member 304 on which the surface projection portions 406 are formed, so that the surface projection portions 406 being adjacent to each other with the smallest distance therebetween are selected. The arrangement of the surface projection portions 406 is observed and measured with a 3D-shape measuring machine. In Example 1, a distance between the surface projection portions 406 is measured by using “One-shot 3D measuring macroscope VR-3200” (product name, manufactured by Keyence Corporation) as the 3D-shape measuring machine. First, any appropriate surface projection portion 406X is selected from the surface side of the slid member 304 on which the surface projection portions 406 are formed. Concentric circles are drawn around a center point of the tip area of the surface projection portion 406X so that the surface projection portion 406Y at the shortest distance from the surface projection portion 406X is extracted. After the surface projection portion 406X and the surface projection portion 406Y are specified, the slid member 304 is cut along a cross section passing through the center points of the tip areas of the surface projection portions 406X and 406Y. A cross section of the two surface projection portions 406X and 406Y is observed with a scanning electron microscope (SEM) (product name: JSM-F100, manufactured by JEOL Ltd.), and the thicknesses of the slid layer 304b are calculated.

### <Evaluation 2>Drive Endurance Test

For this evaluation, a full-color electrophotographic image forming apparatus (product name: imagePRESS V1000; manufactured by CANON KABUSHIKI KAISHA) is prepared. A drive endurance test is carried out in a mode in which the pressure rotary member 305 is alternately brought into a contact state and a non-contact state with the fixing rotary member 301. Design target time in this mode in Evaluation 2 is set to 500 hours. When a driving torque exceeded a preset upper limit value within the design target time, the drive endurance test is terminated. When the driving torque did not exceed the upper limit value, the drive endurance test is terminated after the elapse of the design target time. The above-mentioned upper limit value of the driving torque is set to 300 mNm at which there is a risk of generation of a defective image or damage on a drive gear due to slip.

For the evaluation, 50 ml of the lubricant 309 is first applied onto the surface of the slid member 304 being a target to be evaluated, on which the surface projection portions 406 are formed. The lubricant 309 contained perfluoropolyether (product name: Demnum S-200; manufactured by Daikin Industries, Ltd.) as a base oil, and contained fluororesin particles (product name: Lubron L-5F; manufactured by Daikin Industries, Ltd.) as a thickening agent at 30 mass % with respect to the lubricant 309. The base oil had a kinematic viscosity of 200 mm²/s at a temperature of 40° C.

Subsequently, the slid member 304 fixed onto the outer surface of the pad 303 of the fixing apparatus 8 of the full-color electrophotographic image forming apparatus is removed. The lubricant 309 that had been prepared as described above is applied onto the surface of the removed slid member 304. The slid member 304 being a target to be evaluated, on which the lubricant 309 is applied, is mounted in the full-color electrophotographic image forming apparatus. The above-mentioned drive endurance test is conducted with the full-color electrophotographic image forming apparatus. The endurance test is conducted for up to 500 hours while torque data of the fixing rotary member 301 is being acquired. A state of the slid member 304 is observed every 50 hours.

Abrasion resistance and the state of the slid member 304 are evaluated based on the following evaluation criteria.

### Evaluation Criteria for Abrasion Resistance

Rank A: Driving torque is less than 270 mNm at the end of 500-hour endurance.
Rank B: Driving torque is 270 mNm or more at the end of 500-hour endurance.
Rank C: Driving torque reaches the upper limit before the end of 500-hour endurance, and the endurance test is stopped.

### Evaluation Criteria for the State of the Slid Member

Rank A: No separation occurs at the end of 500-hour endurance.
Rank B: Slight separation occurs at the surface projection portions of the slid layer (less than 3% of the total)
Rank C: Separation occurs at the surface projection portions of the slid layer (3% or more of the total)
Rank D: Separation occurred at the surface projection portions of the slid layer (10% or more of the total)

Every 100 hours, a melting unevenness evaluation image formed over an entire range is printed on an entire surface of an evaluation paper sheet of A4 size (EN100 (64 g/m₂) manufactured by CANON KABUSHIKI KAISHA) with a cyan toner and a magenta toner at a density of 100%, and the presence/absence of an image detect is evaluated through visual observation based on the following evaluation criteria.

Evaluation criteria
Rank A: No image defect
Rank B: A slight image defect in only small part of an image
Rank C: An image defect observed during the endurance

The results of evaluations are shown in Table 1 (Table 1-1 and Table 1-2). In the slid member 304 obtained in Example 1, the thicknesses hA, hB, hC_{F}, and hC_{R} of the slid layer 304b of the surface projection portion 406 are sufficiently large. Thus, no increase in torque occurs throughout the drive endurance test. Further, no separation of the slid layer 304b is observed even after the drive endurance test for 500 hours. Further, a satisfactory result is obtained without any image defect.

TABLE 1-1

| | Shape of base projection portion | | | | | Conditions of formation of slid layer | | |
|---|---|---|---|---|---|---|---|---|
| | H1 | θ | W | d | D | Application | Baking | Smoothing |
| | μm | ° | μm | μm | μm | conditions | conditions | process |
| Example 1 | 250 | 70 | 1,000 | 350 | 532 | Centrifugal | Facing downward at | Pressing |
| | | | | | | force of 1.9G | inclination of 15° | |
| Example 2 | 250 | 70 | 1,000 | 350 | 532 | Centrifugal | Facing downward at | Polishing |
| | | | | | | force of 1.9G | inclination of 15° | |
| Example 3 | 250 | 70 | 1,000 | 350 | 532 | Centrifugal | Facing downward at | Pressing |
| | | | | | | force of 1.9G | inclination of 15° | |
| Example 4 | 250 | 70 | 1,000 | 350 | 532 | Centrifugal | Facing downward | Pressing |
| | | | | | | force of 1.9G | without inclination | |
| Example 5 | 250 | 70 | 1,000 | 150 | 332 | Centrifugal | Facing downward | Polishing |
| | | | | | | force of 1.9G | without inclination | |
| Example 6 | 250 | 45 | 1,140 | 350 | 850 | Centrifugal | Facing downward | Pressing |
| | | | | | | force of 1.9G | without inclination | |
| Example 7 | 215 | 80 | 1,200 | 400 | 476 | Centrifugal | Facing downward | Pressing |
| | | | | | | force of 1.9G | without inclination | |
| Comparative | 250 | 70 | 1,000 | 350 | 532 | Application | Facing upward | — |
| Example 1 | | | | | | with facing | | |
| | | | | | | downward | | |
| Comparative | 250 | 70 | 1,000 | 350 | 532 | Application | Facing upward | — |
| Example 2 | | | | | | with facing | | |
| | | | | | | downward | | |
| Comparative | 200 | 70 | 1,000 | 350 | 496 | Application | Facing upward | — |
| Example 3 | | | | | | with facing | | |
| | | | | | | downward | | |
| Comparative | 250 | 85 | 1,000 | 350 | 394 | Application | Facing upward | — |
| Example 4 | | | | | | with facing | | |
| | | | | | | downward | | |

TABLE 1-2

| | Thickness of slid layer | | | | Height of | | | |
|---|---|---|---|---|---|---|---|---|
| | | | Upstream | Downstream | surface | | | |
| | Tip | Flat | edge portion | edge portion | projection | | | |
| | area | portion | of tip area | of tip area | portions | Results of evaluations | | |
| | hA | hB | hC_{F} | hC_{R} | H | Torque | | Image |
| | μm | μm | μm | μm | μm | change | Separation | defect |
| Example 1 | 60 | 45 | 40 | 30 | 265 | A | A | A |
| Example 2 | 60 | 45 | 40 | 30 | 265 | A | A | A |
| Example 3 | 40 | 30 | 40 | 30 | 260 | A | A | A |
| Example 4 | 60 | 45 | 35 | 35 | 265 | A | B | A |
| Example 5 | 30 | 25 | 10 | 10 | 255 | B | B | A |
| Example 6 | 60 | 45 | 40 | 40 | 265 | A | A | A |
| Example 7 | 60 | 45 | 40 | 40 | 230 | A | A | B |
| Comparative | 30 | 45 | 3 | 3 | 235 | C | C | B |
| Example 1 | | | | | | | | |
| Comparative | 60 | 90 | 3 | 3 | 220 | C | C | B |
| Example 2 | | | | | | | | |
| Comparative | 30 | 45 | 3 | 3 | 185 | C | C | C |
| Example 3 | | | | | | | | |
| Comparative | 25 | 45 | 0 | 0 | 230 | C | D | C |
| Example 4 | | | | | | | | |

### Example 2

The slid member 304 is obtained in the same manner as that in Example 1 except that polishing is performed as the smoothing process. An initial torque had a value lower than that obtained by using pressing as the smoothing process, but a slight increase in torque is observed. However, the torque value is sufficiently lower than the torque upper limit value of 300 mNm, and satisfactory results are obtained for all of the torque value, the presence/absence of separation, and the presence/absence of an image defect.

### Example 3

The slid member 304 is obtained in the same manner as that in Example 1 except that the thickness hA of the slid layer 304b of the tip area of the surface projection portion 406 is set to 40 μm. A slight increase in torque is observed in a latter half of the endurance as compared to the case of Example 1. However, the torque value is sufficiently lower than the torque upper limit value of 300 mNm, and satisfactory results are obtained for all of the torque value, the presence/absence of separation, and the presence/absence of an image defect.

### Example 4

The slid member 304 is obtained in the same manner as that in Example 1 except that baking is performed without any inclination in the baking step of the slid layer 304b. Separation of the slid layer 304b is observed for some of the surface projection portions 406 after the endurance. However, the separation is found in less than 3% of the total, and there is no influence on the torque value or the image. Thus, satisfactory results are obtained.

### Example 5

The slid member 304 is obtained in the same manner as that in Example 2 except that the diameter “d” of the tip area 405a of the base projection portion 405 is set to 150 μm, baking is performed without any inclination in the baking step, and the thickness hA of the slid layer 304b of the tip area of the surface projection portion 406 is set to 30 μm. The diameter “d” of the tip area 405a of the base projection portion 405 is set small, and hence a torque including an initial torque is higher than that in Example 2. Further, the tip area of the surface projection portion 406 is small, and hence stress is concentrated on the tip area. As a result, an increase in torque is observed throughout the endurance test. The torque value exceeded 270 mNm after the endurance for 500 hours, but did not exceed the torque upper limit value of 300 mNm. Regarding the tip areas of the surface projection portions 406, separation of the slid layer 304b is observed in the tip areas of some of the surface projection portions 406. However, the separation is found in less than 3% of the total. Thus, satisfactory results are obtained.

### Example 6

The slid member 304 is obtained through the same steps as those in Example 4 except that the center-to-center distance W between the base projection portions 405 is set to 1,140 μm and the rising angle θ of the base projection portion 405 is set to 45°. Satisfactory results are obtained for the torque value, the presence/absence of separation, and the presence/absence of an image defect throughout the endurance test.

### Example 7

The slid member 304 is obtained through the same steps as those in Example 4 except that the height H1 of the base projection portion 405 is set to 215 μm, the rising angle θ of the base projection portion 405 is set to 80°, the center-to-center distance W between the base projection portions 405 is set to 1,200 μm, and the diameter “d” of the tip area 405a of the base projection portion 405 is set to 400 μm. Satisfactory results are obtained for a torque change and the presence/absence of separation throughout the endurance test. A slight image defect is observed in a latter half of the endurance in the image evaluations. It is considered that this is because the height H of the surface projection portions 406 is as low as 230 μm and hence jamming of abrasion powder or the like occurred in the latter half of the endurance, resulting in slight pressure unevenness occurring at the nip portion N between the fixing rotary member 301 and the slid member 304.

### Comparative Example 1

The slid member 304 is obtained by carrying out the coating step and the baking step, which have been changed in the following manner, on a base 304a that is similar to the base 304a prepared in Example 1.

### (Formation of Slid Layer)

A dispersion liquid of polyether ether ketone (PEEK) (product name: VICOTE (trademark) F817, manufactured by Victrex Plc.) is prepared. A coating material had a viscosity of 63 mPa·s (23° C.). Subsequently, the base 304a prepared as described above is stationarily placed with its surface having the base projection portions 405 facing upward. The dispersion liquid is applied from above onto the base 304a with use of a spray gun (product name: W-101, manufactured by ANEST IWATA Cooperation) to thereby form a coating film of the dispersion liquid. Subsequently, the base 304a with the coating film formed thereon is placed in a heating furnace and heated at a temperature of 120° C. for 5 minutes. After the coating film is dried, the base 304a is heated at a temperature of 400° C. for 15 minutes to bake the coating film. In this manner, a first PEEK resin layer is formed so that the slid layer 304b on the tip area 405a of the base projection portion 405 had a thickness of 10 μm.

A step of applying a dispersion liquid of polyether ether ketone (PEEK) (product name: VICOTE (trademark) F804, manufactured by Victrex Plc.) onto the first PEEK resin layer formed as described above is carried out. A coating material had a viscosity of 92 mPa's (23° C.). First, the base 304a prepared as described above is stationarily placed with its surface having the base projection portions 405 facing upward. The dispersion liquid is applied from above onto the base 304a with use of a spray gun (product name: W-101, manufactured by ANEST IWATA Cooperation) to thereby form a coating film of the dispersion liquid. Subsequently, the base 304a with the coating film formed thereon is placed in a heating furnace and heated at a temperature of 120° C. for 5 minutes to thereby dry the coating film. After that, the base 304a is placed in the heating furnace with the surface having the surface projection portions 406 being kept facing upward, to be heated at a temperature of 400° C. for 15 minutes to thereby bake the coating film. In this manner, a second PEEK resin layer is formed.

The thickness hA of the slid layer 304b of the surface projection portion 406 of the resultant slid member 304 is 30 μm, and the thickness hB of the slid layer 304b on the flat portion 407 is 45 μm.

An endurance test is conducted on the resultant slid member 304 in the same manner as that in Example 1. In Comparative Example 1, an increase in torque is observed even in an initial period of the endurance and exceeded 300 mNm, which is an upper limit, after elapse of 300 hours. Thus, the endurance test is stopped. As a result of the observation of the surface of the slid member 304, the separation of the slid layer 304b of the surface projection portions 406, which exceeded 5% of the total, is observed. The reason therefor is presumed as follows. The coating liquid flowed from the tip areas 405a of the base projection portions 405 to the flat portions 407 at the time of application and baking. In this process, the slid layer 304b has small thicknesses hC_{F} and hC_{R} in the edge portions of the tip area of the surface projection portion 406. Hence, the separation is prone to occur. It is considered that an increase in torque occurred as a result of exposure of the metal layer of the base 304a due to a large amount of separation.

### Comparative Example 2

The slid member 304 is obtained by carrying out the same steps as those in Comparative Example 1, on a base 304a similar to the base 304a prepared in Example 1. At the time of formation of the coating film, the application conditions are changed so that the slid layer 304b of the surface projection portion 406 had the thickness hA of 60 μm.

An endurance test is conducted on the resultant slid member 304 in the same manner as that in Example 1. In Comparative Example 2, an increase in torque is observed even in an initial period of the endurance and exceeded 300 mNm, which is an upper limit, after elapse of 300 hours. Thus, the endurance test is stopped. As a result of the observation of the surface of the slid member 304, the separation of the slid layer 304b of the surface projection portions 406, which exceeds 5% of the total, is observed. The reason therefor is presumed as follows. The coating liquid flowed from the tip areas 405a of the base projection portions 405 to the flat portions 407 at the time of application and baking. In this process, the slid layer 304b has small thicknesses hC_{F} and hC_{R} in the edge portions of the tip area of the surface projection portion 406. Hence, the separation is prone to occur. It is considered that an increase in torque occurred as a result of exposure of the metal layer of the base 304a due to a large amount of separation. Further, as a result of an increase in the thickness hB of the slid layer 304b on the flat portion 407, the surface projection portion 406 had a low height H. After elapse of about 300 hours, which is in the latter half of the endurance, an image defect that seemed to be caused by jamming of foreign matter such as abrasion powder is observed. After elapse of 400 hours, the torque reached the upper limit torque, and hence the test is stopped.

### Comparative Example 3

The slid member 304 is obtained through the same steps as those in Comparative Example 1 except that the height H1 of the base projection portion 405 is changed to 200 μm. The slid member 304 obtained in Comparative Example 3 has a low height H for the surface projection portions 406 from the beginning, and an image defect is observed after elapse of 100 hours in an early stage of the endurance. After elapse of 250 hours, the torque reaches the upper limit torque, and hence the test is stopped.

### Comparative Example 4

The slid member 304 is obtained through the same steps as those in Comparative Example 1 except that the rising angle θ of the base projection portion 405 is increased to 85°. Due to steep rise of the base projection portion 405, flow of the coating liquid is liable to occur in the processing step. Thus, in the observation before the endurance test, the absence of the slid layer 304b is observed in the edge portions of the tip areas of some of the surface projection portions 406. In the endurance test, the torque reached the upper limit torque value after elapse of 200 hours. Hence, the test is stopped.

According to the present disclosure, the slid member 304, the fixing apparatus 8, the image forming apparatus 1, and the manufacturing method for the slid member 304, which are capable of suppressing an image defect caused by undesirable jamming of foreign matter or an increase in torque due to the separation of the slid layer 304b even during and after the endurance for a long period of time, can be provided.

According to the embodiment of the present disclosure, the slid member 304 capable of suppressing exposure of the base 304a made of metal or separation of the slid layer 304b due to abrasion of the slid layer 304b even during and after use for a long period of time, and the fixing apparatus 8, can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-210989, filed Dec. 4, 2024, which is hereby incorporated by reference herein in its entirety.

What is claimed is:

1. A slid member, comprising:
a metal base having a surface on which a plurality of base projection portions are formed; and
a slid layer that covers the surface of the metal base on which the plurality of base projection portions are formed,
wherein a height H of surface projection portions, which are formed with the base projection portions and the slid layer that covers the base projection portions, is 230 μm or more,
wherein a diameter “d” of a tip area of each of the base projection portions is 400 μm or less,
wherein a rising angle θ of each of the base projection portions is from 35° to 80°,
wherein, assuming that any appropriate base projection portion among the base projection portions is defined as a base projection portion X and a base projection portion among the base projection portions being closest to the base projection portion X is defined as a base projection portion Y, a center-to-center distance W (mm) between a center of the base projection portion X and a center of the base projection portion Y is 1.2 or less,
wherein a height H1 of the base projection portions, the diameter “d”, the rising angle θ, and the center-to-center distance W satisfy a relationship of W×1,000>d+2 (H1/tan θ), and
wherein a thickness hA of the slid layer of a tip area of the surface projection portions is larger than a thickness hB of the slid layer coating a portion between the base projection portions.

2. The slid member according to claim 1, wherein the portion between the base projection portions is a flat portion.

3. The slid member according to claim 1, wherein the slid layer is formed of a resin.

4. The slid member according to claim 1, wherein a thickness hC_{F} of the slid layer on one side edge portion of an edge portion of the tip area of the base projection portion is 30% or more of the thickness hA of the slid layer on a center portion of the tip area of the base projection portion.

5. The slid member according to claim 1, wherein a thickness hC_{F} of the slid layer on one side edge portion of an edge portion of the tip area of the base projection portion is larger than a thickness hC_{R} of the slid layer on another side edge portion located on a side opposite to the one side edge portion.

6. The slid member according to claim 1, wherein the tip area of the base projection portion has a substantially flat circular shape.

7. A fixing apparatus, which is configured to fix an unfixed toner image born on a recording material to the recording material, the fixing apparatus comprising:
a fixing rotary member;
a pressure rotary member, which is arranged so as to be opposed to the fixing rotary member, and forms a nip portion in cooperation with the fixing rotary member;
a slid member, which is arranged in an inner side of the fixing rotary member, and has a slid surface being contactable with an inner peripheral surface of the fixing rotary member through a lubricant;
a pressing member, which is arranged in the inner side of the fixing rotary member and is configured to press the fixing rotary member against the pressure rotary member through the slid member; and
a heater configured to heat the fixing rotary member,
wherein the slid member comprises:
a metal base having a surface on which a plurality of base projection portions are formed; and
a slid layer that covers the surface of the metal base on which the plurality of base projection portions are formed,
wherein a height H of surface projection portions, which are formed with the base projection portions and the slid layer that covers the base projection portions, is 230 μm or more,
wherein a diameter “d” of a tip area of each of the base projection portions is 400 μm or less,
wherein a rising angle θ of each of the base projection portions is from 35° to 80°,
wherein, assuming that any appropriate base projection portion among the base projection portions is defined as a base projection portion X and a base projection portion among the base projection portions being closest to the base projection portion X is defined as a base projection portion Y, a center-to-center distance W (mm) between a center of the base projection portion X and a center of the base projection portion Y is 1.2 or less,
wherein a height H1 of the base projection portions, the diameter “d”, the rising angle θ, and the center-to-center distance W satisfy a relationship of W×1,000>d+2 (H1/tan θ),
wherein a thickness hA of the slid layer of a tip area of the surface projection portions is larger than a thickness hB of the slid layer coating a portion between the base projection portions, and
wherein the surface of the slid member on which the surface projection portions are provided is arranged so as to be opposed to the inner peripheral surface of the fixing rotary member.

8. An image forming apparatus comprising:
an image forming portion configured to form the unfixed toner image on the recording material; and
the fixing apparatus as recited in claim 7.

9. A manufacturing method of manufacturing a slid member, the manufacturing method comprising:
a coating step of spray-coating a surface of a metal base, on which a plurality of base projection portions are formed, with a coating material containing a resin for forming a slid layer; and
a baking step of baking the resin contained in the coating material applied on the surface to form a resin layer as the slid layer,
wherein the coating step includes spray-coating the surface with the coating material while rotating the metal base so that a centrifugal force of 1.5 G or more and 3.0 G or less is applied to tip areas of the base projection portions in a direction toward tips of the base projection portions,
wherein the baking step includes heating the slid member to a melting point or higher of the resin forming the resin layer in a state in which the slid member is arranged in such an orientation that a gravitational force is applied in the direction toward the tips of the base projection portions, and then cooling the slid member in a state in which the slid member is kept in the orientation,
wherein the slid member comprises:
the metal base having the surface on which the plurality of base projection portions are formed; and
the slid layer that covers the surface of the metal base on which the plurality of base projection portions are formed,
wherein a height H of surface projection portions, which are formed with the base projection portions and the slid layer that covers the base projection portions, is 230 μm or more,
wherein a diameter “d” of a tip area of each of the base projection portions is 400 μm or less,
wherein a rising angle θ of each of the base projection portions is from 35° to 80°,
wherein, assuming that any appropriate base projection portion among the base projection portions is defined as a base projection portion X and a base projection portion among the base projection portions being closest to the base projection portion X is defined as a base projection portion Y, a center-to-center distance W (mm) between a center of the base projection portion X and a center of the base projection portion Y is 1.2 or less,
wherein a height H1 of the base projection portions, the diameter “d”, the rising angle θ, and the center-to-center distance W satisfy a relationship of W×1,000>d+2(H1/tan θ), and
wherein a thickness hA of the slid layer of a tip area of the surface projection portions is larger than a thickness hB of the slid layer coating a portion between the base projection portions.

10. The manufacturing method according to claim 9, further comprising performing a smoothing process on the tip areas of the surface projection portions after the baking step.
